(19) United States
(12) Patent Application Publication
(10) Pub. No.: US 2010/0154965 A1
(43) Pub. Date: Jun. 24, 2010

(54) OFFSET ZIGZAG BELT STRUCTURE FOR A PNEUMATIC TIRE

(76) Inventors: Roland Willibrord Krier, Biwer (LU); Vincent Benoit Mathonet, Habay la Neuve (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/339,546

(22) Filed: Dec. 19, 2008

(51) Int. Cl. B60C 9/18

(52) U.S. Cl. 152/538

(57) ABSTRACT

A pneumatic tire has a carcass and a belt reinforcing structure. The belt reinforcing structure includes a first zigzag belt layer having a first amplitude and a first wavelength and a second zigzag belt layer having a second amplitude and a second wavelength. The first wavelength of the first zigzag layer is out of phase with the second wavelength of the second zigzag layer.

### FIELD OF THE INVENTION

This invention relates to a pneumatic tire having a carcass and a belt reinforcing structure, and, more particularly, to a heavy load radial ply tire having a carcass and a high strength belt structure.

### BACKGROUND OF THE INVENTION

In a conventional pneumatic tire, a large number of belt plies, which stiffen the crown area, are sandwiched on top of one another and are susceptible to cracks inside the belt layers. These cracks may subsequently grow both axially and radially outward, causing a sudden cut/peel off and scattering of the belt/tread during operation.

In one conventional tire, zigzag belt layers have been utilized for the radially inner belt layers with the cord angles progressively increasing from the radially inner belt layers toward the radially outer belt layers. Thus, inner belt plies may contain cords extending substantially in a zigzag path at a cord angle of 5 degrees to 15 degrees in the circumferential direction with respect to the equatorial plane, while being bent at both sides, or lateral edges, of the plies. Each of the outer belt plies may contain cords having a cord angle B larger than the cord angle A of the inner belt plies.

In another conventional tire, each of the side end portions between adjoining inner zigzag belt plies is provided with a further extra laminated portion of a strip continuously extending in the circumferential direction. Further, the extra laminated portions may be sandwiched one upon another in the radial direction. It has been found that the circumferential rigidity of this tire in the vicinity of the lateral edge of each ply end or tread edge is locally increased in this manner so that the radial growth in the vicinity of the tread edge portion during running at high speed may be reduced.

Still another conventional tire has a carcass and a composite belt reinforcing structure having a pair of radially outer zigzag layers and a spirally wound belt layer with cords inclined at an inclination of 5 degrees or less in the circumferential direction with respect to the equatorial plane and located radially inward of, and adjacent to, the radially outer zigzag belt layers. The radially outer zigzag belt layers have cords inclined at 5 degrees to 30 degrees in the circumferential direction with respect to the equatorial plane and extending in alternation to turnaround points at each lateral edge of the belt layer. At each turnaround point, the cords are folded or preferably bent to change direction across the crown of the carcass thus forming a zigzag cord path. The radially inner zigzag belt layers are positioned between the carcass and the spirally wound belt layer. Each of the radially inner zigzag belt layers has cords wound at an inclination of 5 degrees to 30 degrees in the circumferential direction with respect to the equatorial plane and extending in alternation to turnaround points at each lateral edge of the belt layers.

### SUMMARY OF THE INVENTION

In accordance with one example embodiment of the present invention, a pneumatic tire has a carcass and a belt reinforcing structure. The belt reinforcing structure includes a first zigzag belt layer having a first amplitude and a first wavelength and a second zigzag belt layer having a second amplitude and a second wavelength. The first wavelength of the first zigzag layer is out of phase with the second wavelength of the second zigzag layer.

According to another aspect of the present invention, the first zigzag belt layer comprises cords inclined an amount in the range of 3.0 to 8.5 degrees relative to an equatorial plane of the pneumatic tire.

According to still another aspect of the present invention, the second zigzag layer comprises cords inclined an amount in the range of 3.0 to 8.5 degrees relative to an equatorial plane of the pneumatic tire.

According to yet another aspect of the present invention, the pneumatic tire further includes a circumferential spirally wound layer interposed between the first zigzag layer and the second zigzag layer.

According to still another aspect of the present invention, the circumferential spirally wound layer comprises cords inclined an amount in the range of 0 to 5 degrees relative to an equatorial plane of the pneumatic tire.

According to yet another aspect of the present invention, the first zigzag layer is out of phase by Π/2 radians with the second zigzag layer.

According to still another aspect of the present invention, the first zigzag layer is disposed radially inward of the second zigzag layer.

In accordance with another example embodiment of the present invention, a pneumatic tire has a carcass and a belt reinforcing structure. The belt reinforcing structure includes a first zigzag belt layer having a first amplitude and a first wavelength and a second zigzag belt layer having a second amplitude and a second wavelength. The first wavelength of the first zigzag layer is 90 degrees out of phase with the second wavelength of the second zigzag layer.

According to another aspect of the present invention, the first zigzag belt layer comprises cords inclined an amount in the range of 3.0 to 8.5 degrees relative to an equatorial plane of the pneumatic tire.

According to still another aspect of the present invention, the second zigzag layer comprises cords inclined an amount in the range of 3.0 to 8.5 degrees relative to an equatorial plane of the pneumatic tire.

According to yet another aspect of the present invention, the pneumatic tire further includes a circumferential spirally wound layer interposed between the first zigzag layer and the second zigzag layer.

According to still another aspect of the present invention, the circumferential spirally wound layer comprises cords inclined an amount in the range of 0 to 5 degrees relative to an equatorial plane of the pneumatic tire.

According to yet another aspect of the present invention, the first zigzag layer is disposed radially inward of the second zigzag layer.

According to still another aspect of the present invention, the first amplitude is greater than the second amplitude.

According to yet another aspect of the present invention, the first zigzag layer, the second zigzag layer, and the circumferential spirally wound layer are formed from a continuous strip of material.

### DEFINITIONS

“Apex” means a non-reinforced elastomer positioned radially above a bead core.

“Aspect ratio” of the tire means the ratio of its section height (SH) to its section width (SW) multiplied by 100% for expression as a percentage.

“Axial” and “axially” mean lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Cut belt” or “cut breaker reinforcing structure” means at least two cut layers of plies of parallel cords, woven or unwoven, underlying the tread, unanchored to the bead, and having both left and right cord angles in the range from 10 degrees to 33 degrees with respect to the equatorial plane of the tire.

“Bias ply tire” means a tire having a carcass with reinforcing cords in the carcass ply extending diagonally across the tire from bead core to bead core at about a 25-50 degree angle with respect to the equatorial plane of the tire. Cords run at opposite angles in alternate layers.

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Chafers” refer to narrow strips of material placed around the outside of the bead to protect cord plies from the rim, distribute flexing above the rim, and to seal the tire.

“Chippers” mean a reinforcement structure located in the bead portion of the tire.

“Cord” means one of the reinforcement strands of which the plies in the tire are comprised.

“Equatorial plane (EP)” means the plane perpendicular to the tire's axis of rotation and passing through the center of its tread.

“Flipper” means a reinforced fabric wrapped about the bead core and apex.

“Footprint” means the contact patch or area of contact of the tire tread with a flat surface at zero speed and under normal load and pressure

“Innerliner” means the layer or layers of elastomer or other material that form the inside surface of a tubeless tire and that contain the inflating fluid within the tire.

“Net-to-gross ratio” means the ratio of the tire tread rubber that makes contact with the road surface while in the footprint, divided by the area of the tread in the footprint, including non-contacting portions such as grooves.

“Nominal rim diameter” means the average diameter of the rim flange at the location where the bead portion of the tire seats.

“Normal inflation pressure” refers to the specific design inflation pressure and load assigned by the appropriate standards organization for the service condition for the tire.

“Normal load” refers to the specific design inflation pressure and load assigned by the appropriate standards organization for the service condition for the tire.

“Ply” means a continuous layer of rubber-coated parallel cords.

“Radial” and “radially” mean directions radially toward or away from the axis of rotation of the tire.

“Radial-ply tire” means a belted or circumferentially-restricted pneumatic tire in which the ply cords which extend from bead to bead are laid at cord angles between 65-90 degrees with respect to the equatorial plane of the tire.

“Section height” (SH) means the radial distance from the nominal rim diameter to the outer diameter of the tire at its equatorial plane.

“Zigzag belt reinforcing structure” means at least two layers of cords or a ribbon of parallel cords having 2 to 20 cords in each ribbon and laid up in an alternating pattern extending at an angle between of 2-30 degrees between lateral edges of the belt layers.

### BRIEF DESCRIPTION OF THE DRAWINGS

FIG. 1 is a schematic sectional view of part of a tire according to the present invention;

FIG. 2 is a schematic perspective view of a zigzag belt layer during formation in accordance with the present invention;

FIG. 3 is a schematic radial view of part of two circumferentially offset zigzag belt layers in accordance with the present invention;

FIG. 4 is a schematic enlarged radial view of an example of part of one of the zigzag belt layers of FIG. 3;

FIG. 5 is a schematic enlarged radial view of another example of part of one of the zigzag belt layers of FIG. 3; and

FIG. 6 is a schematic radial view a zigzag belt layer in accordance with the present invention.

### DETAILED DESCRIPTION OF AN EXAMPLE EMBODIMENT THE INVENTION

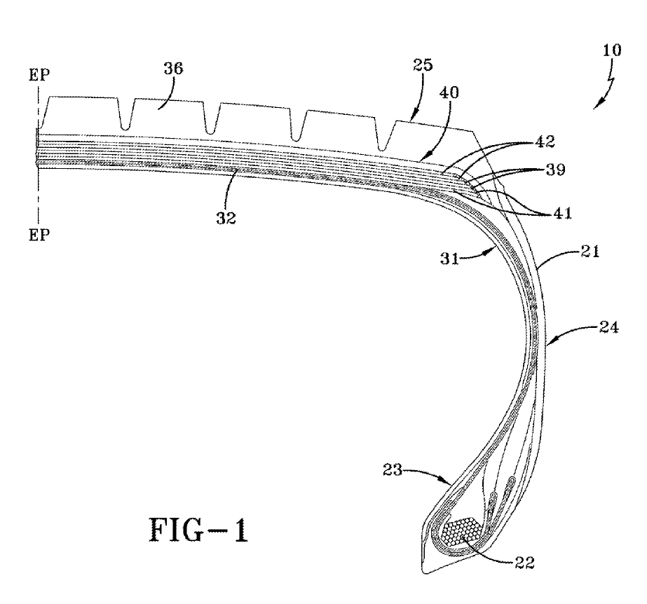

As shown in the half cross-section of FIG. 1, an example radial tire 10 in accordance with the present invention includes two bead portions 23 (one shown) each with a bead core 22 embedded therein, two sidewall portions 24 (one shown) extending radially and slightly axially outward from each of the bead portions 23 in the radial direction of the tire, and a cylindrical tread portion 25 extending between radially outer ends of the sidewall portions 24. The tire 10 is reinforced by a carcass 31 toroidally extending from one bead portion 23 to the other bead portion 23 (not shown).

The carcass 31 may include at least one carcass ply 32 (FIG. 1). The carcass ply 32 may wind around each bead core 22 from inside of the tire 10 away from the equatorial plane EP to form turnup portions. A tread pattern 36 is arranged radially outside of the carcass 31.

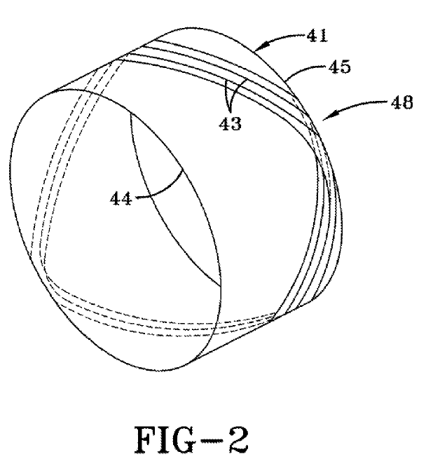

A belt structure 40 is arranged between the carcass 31 and the tread portion 25. The belt structure 40, according to an example embodiment of the present invention, comprises an inner belt layer 41 disposed radially adjacent the carcass 31 and an outer belt layer 42 disposed radially adjacent the tread portion 25. As shown in FIGS. 2 and 6, multiple plies of the inner belt layer 41 may be formed by winding a rubberized strip 43 of one or more steel or aramid cords 46 around a drum in a generally circumferential direction while being angled to extend between side ends, or lateral edges 44, 45, of the inner belt layer thereby forming a zigzag path.

The rubberized strip 43 may be further wound many times while the strip is shifted approximately a width of the strip in the circumferential direction so as not to form a gap between adjoining strips 43. As a result, the cords 46 extend substantially zigzag in the circumferential direction while changing the bending direction at a turnaround point 48 at both lateral edges 44, 45. The cords 46 may be further embedded uniformly throughout the inner belt layer 41. Moreover, the cords 46 may overlap one another such that multiple plies of the inner belt layer 41 are formed while crossing the cords 46 with each other.

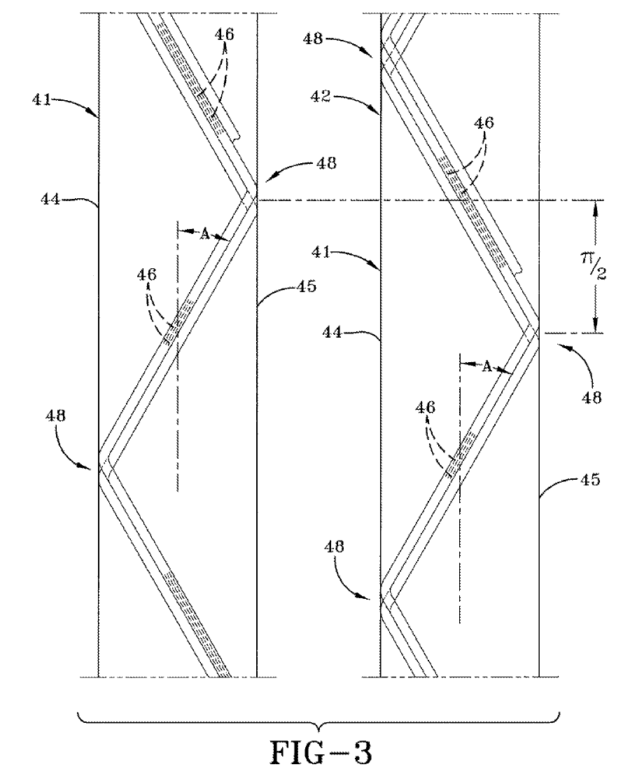

Similarly, as shown in FIG. 3, multiple plies of the radially outer belt layer 42 may be formed by the same method. The width of the outer belt layer 42, or the amplitude of the zigzag pattern of the outer belt layer, may be less than the width/amplitude of the inner belt layer 41. Optionally, interposed between the inner belt layer 41 and outer belt layer 42 may be a circumferential, spirally wound layer 39 (FIG. 1) of cords 46, the cords being wound at an angle of plus or minus 5 degrees or less relative to the equatorial plane EP of the tire 10.

The cords 46 of the inner belt layer 41 and outer belt layer 42 may cross with each other at a cord angle A of 2 degrees to 16 degrees, or more specifically 3.0 degrees to 8.5 degrees such as 5 degrees or 6.54 degrees, with respect to the equatorial plane EP of the tire 10 when the strip 43 is reciprocated at least once between both lateral edges 44, 45 of the inner layer within every 360 degrees of the circumference of the tire, as shown in FIG. 3.

If the cord 46 was a nylon cord and the compressive strain would exceed 25%, cord fatigue could result. However, when a ratio of R/W (R is a radius of curvature (mm) of the strip 43 at the side lateral edges 44, 45 of the inner belt layer 41, and W is a width (mm) of the strip 43) is 2.0 or greater, as shown in FIG. 4, compressive strain in the cord 46 may not exceed 25%. Therefore, when the inner belt layer 41 is formed by using a rubberized strip 43 containing plural steel or aramid cords 46 therein, for example, it may be desirable that the value of R/W is not less than 2.0. The width W of the strip 43 may be in the range of 5 mm to 15 mm, or more specifically in the range of 12 mm to 14 mm.

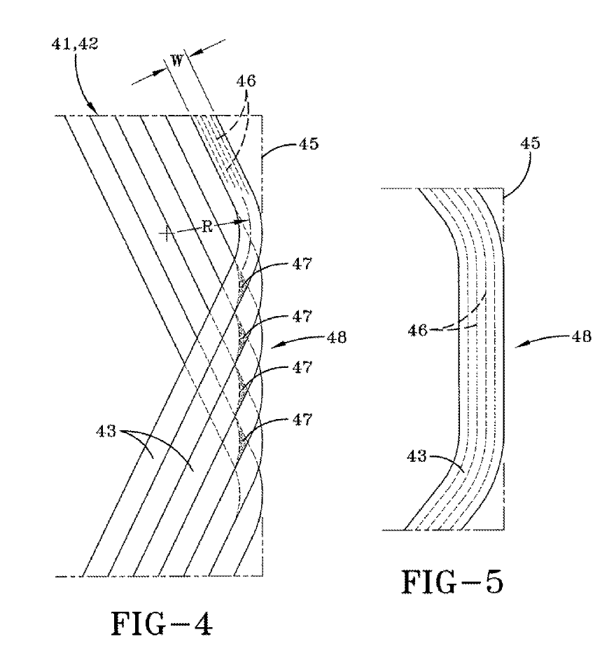

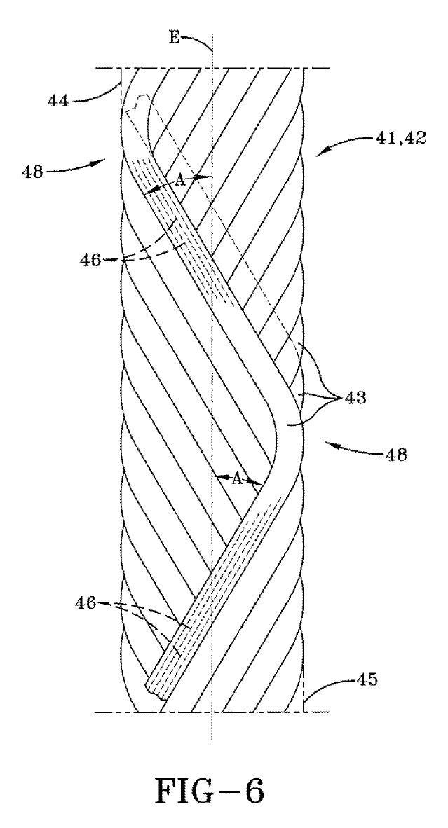

In addition to a case where the strip 43 is bent at both side lateral edges 44, 45 of the inner belt layer 41 in an arc configuration, as shown in FIG. 4, the strip may have a straight portion extending along the side lateral edge 44 or 45 and an arc portion located at each end of a straight portion (FIG. 5). Here too, it is desirable that the value of R/W in the arc portion not be less than 2.0. Further, when the strip 43 is wound while being bent with a given radius of curvature R at both side lateral edges 44, 45 of the inner belt layer 41, a zone 47 forming a bent triangle may be formed, as shown in FIG. 4, and repeatedly created in the circumferential direction.

In the example embodiment, the layers 41, 39, and 42 may all be formed from a continuous strip 43 that simply forms the radially inner zigzag layer(s) 41 and then continues to form the at least one spirally wound layer 39 and then continues on to form the radially outer zigzag layer(s) 42. Alternatively, the spirally wound layer(s) 39 could be formed as a separate layer from another strip 43. This alternative permits the cords 46 to be of different size or even of different materials from the inner and outer zigzag layers 41, 42 (i.e., a steel inner layer and an aramid outer layer).

The circumferential, spirally wound layer 39, between the inner and outer zigzag layers 41, 42, may reduce the circumferential growth of the tire 10, not only in the lateral edges 44, 45, but also the crown area of the tread pattern 36. Thus, the circumferential, spirally wound layer 39, by resisting growth in the crown area of the tire 10, may greatly reduce cut propensity due to foreign object damage and also reduce tread cracking, particularly under the tread grooves.

In order to further improve uniformity, footprint shape, high load capability and durability, and wear evenness, as shown in FIG. 3, the pattern of the outer zigzag layer 42 is circumferentially offset, or out of phase, from the inner zigzag layer 41, for example by Π/2 radians (or 90 degrees rotation of the drum of FIG. 2). This offset reduces the number of strips 46 overlapping each other at the lateral edges of the layers 41, 42 thereby reducing the thickness created by the layers at the edges of the tread 25. This, in turn, results in a more uniform belt structure 40 by mitigating concentrations of zero degree portions in the strips 46 and reducing latent stress/wire tension in the strips at the edges of the tread 25. Additional wedges (not shown) may also be disposed between the layers 41, 42 in order to further reduce stress.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire having a carcass and a belt reinforcing structure, the belt reinforcing structure comprising:
a first zigzag belt layer having a first amplitude and a first wavelength; and
a second zigzag belt layer having a second amplitude and a second wavelength,
the first wavelength of the first zigzag layer further being out of phase with the second wavelength of the second zigzag layer.

2. The pneumatic tire of claim 1 wherein the first zigzag belt layer comprises cords inclined an amount in the range of 3.0 to 8.5 degrees relative to an equatorial plane of the pneumatic tire.

3. The pneumatic tire of claim 1 wherein the second zigzag layer comprises cords inclined an amount in the range of 3.0 to 8.5 degrees relative to an equatorial plane of the pneumatic tire.

4. The pneumatic tire of claim 1 further including a circumferential spirally wound layer interposed between the first zigzag layer and the second zigzag layer.

5. The pneumatic tire of claim 4 wherein the circumferential spirally wound layer comprises cords inclined an amount in the range of 0 to 5 degrees relative to an equatorial plane of the pneumatic tire.

6. The pneumatic tire of claim 1 wherein the first zigzag layer is out of phase by Π/2 radians with the second zigzag layer.

7. The pneumatic tire of claim 1 wherein the first zigzag layer is disposed radially inward of the second zigzag layer.

8. The pneumatic tire of claim 1 wherein first wavelength is out of phase by Π/2 radians with the second wavelength.

9. The pneumatic tire of claim 1 wherein a circumferential spirally wound layer is interposed between the first zigzag layer and the second zigzag layer.

10. A pneumatic tire having a carcass and a belt reinforcing structure, the belt reinforcing structure comprising:
a first zigzag belt layer having a first amplitude and a first wavelength; and
a second zigzag belt layer having a second amplitude and a second wavelength,
the first wavelength of the first zigzag layer further being 90 degrees out of phase with the second wavelength of the second zigzag layer.

11. The pneumatic tire of claim 10 wherein the first zigzag belt layer comprises cords inclined an amount in the range of 3.0 to 8.5 degrees relative to an equatorial plane of the pneumatic tire.

12. The pneumatic tire of claim 11 wherein the second zigzag layer comprises cords inclined an amount in the range of 3.0 to 8.5 degrees relative to an equatorial plane of the pneumatic tire.

13. The pneumatic tire of claim 12 further including a circumferential spirally wound layer interposed between the first zigzag layer and the second zigzag layer.

14. The pneumatic tire of claim 13 wherein the circumferential spirally wound layer comprises cords inclined an amount in the range of 0 to 5 degrees relative to an equatorial plane of the pneumatic tire.

15. The pneumatic tire of claim 14 wherein the first zigzag layer is disposed radially inward of the second zigzag layer.

16. The pneumatic tire of claim 15 wherein the first zigzag layer, the second zigzag layer, and the circumferential spirally wound layer are formed from a continuous strip of material.
